(19) United States
(12) Patent Application Publication
(10) Pub. No.: US 2024/0207949 A1
(43) Pub. Date: Jun. 27, 2024

(54) Drilling and Finishing Jig for the Manufacture of Pistols

(71) Applicant: ROOK Tactical LLC, Aledo, TX (US)

(72) Inventor: Peter Mark Middleton, Aledo, TX (US)

(21) Appl. No.: 18/397,443

(22) Filed: Dec. 27, 2023

Related U.S. Application Data
(60) Provisional application No. 63/435,442, filed on Dec. 27, 2022.

(51) Int. Cl. B23B 47/28

(52) U.S. Cl. CPC B23B 47/28; B23B 2215/28; B23B 2247/12; B23B 2260/026

(57) ABSTRACT

A jig for machining firearm frames is described. The jig includes a main body, a top plate, and bushing pockets. Inserts including a rear matched-geometry insert and a front matched-geometry insert are fastened within the main body and positioned to register a location of opposing ends of a blank frame. For example, a beavertail insert shaped complementarily to a proximal end of a firearm, and a rail insert shaped complementarily to a distal end of a firearm may be used as inserts with the jig. A variety of bushing inserts can also be used with the jig to precisely register the locations for desired machining.

### CROSS-REFERENCE TO RELATED APPLICATION(S)

This application claims priority to and the benefit of U.S. Provisional Patent Application Serial No. 63/435,442, filed Dec. 27, 2022, the entire disclosure of which is incorporated herein by reference.

### TECHNICAL FIELD

This disclosure relates to a self-aligning, multi-platform, modular, drilling, and finishing jig for manufacturing firearm frames from unfinished blanks.

### BACKGROUND

When manufacturing polymer pistol frames from unfinished blanks, various machining processes usually need to be completed. If such machining is insufficiently precise, the pistol frame may be unable to function as intended.

### SUMMARY

Disclosed herein are embodiments of a jig that facilitates machining (i.e., finishing) one or more unfinished blank frames (e.g., blank polymer frames for one or more pistols). For example, the jig may be used to guide a user as the user drills holes for a trigger pin, trigger housing pin, support pin, and/or locking block pin. Alternatively, or in addition thereto, the jig may be used to guide a user as the user machines out material for a guide rod channel.

The jig may include one or more guide apertures formed therein. This may enable the user to precisely pass appropriate cutting tools (e.g., drill bits, end mills, or the like) through the one or more guide apertures and remove material from the blank, thereby converting it into a finished frame. The guide apertures may confine or limit the motion of the cutting tool to ensure the proper amount of material from the proper location is removed.

A jig may include one or more inserts, attachments, and/or top plates. Such components may be secured together or with respect to one another to accurately position an unfinished blank in its correct orientation and location in relation to the one or more guide apertures. In selected embodiments, the one or more guide apertures may be formed in or extend through one or more of the inserts, attachments, and/or cover plates. Thus, by swapping in or out one or more of the inserts, attachments, or cover plates, a user may control which guide apertures are to be used in a particular machining or finishing process.

A jig may include one or more pockets formed therein. A pocket may be an opening, aperture, or space for receiving an insert therewithin. In certain embodiments, an insert may have a clearance fit with respect to a corresponding pocket. However, the clearance between the insert and the pocket may be relatively small, and the corresponding tolerances may be relatively tight. Accordingly, the insert may be able to slide into and out of the pocket without being forced, while still having little to no unintentional movement within the pocket. This may insure proper and predictable registration between the insert and the pocket.

One or more inserts may function as or be bushings for guiding a drill bit. The drill guide inserts may be designed to be completely replaceable if that need may ever arise. The jig may also be modular in a fashion that allows it to be adapted and expanded to fit other frames as they may come to market. The modularity of the platform also may allow for replacement parts to be exchanged when needed, thus increasing the life of the jig dramatically. The jig may also have a top plate that assists in holding the frame accurately in place during drilling and can take various inserts, attachments, or guides that are designed to assist in the removal of material from the guide rod channel acting as both a depth guide and template.

Additionally, a jig may be made of aluminum and may be machined to accept steel insert guide bushings, positional precision fitment parts, and a step top guide plate. This construction may allow for a resilient, accurate, and robust jig that is capable of being used multiple times with consistent results. The construction of the jig may prevent a cutting tool from drifting during use and the jig may provide the proper support for precision cutting. The modularity of the jig allows the jig to be compatible across a variety of unfinished blank frames. If the components wear after multiple uses, they may be replaced due to their modular design.

These and other aspects of this disclosure are disclosed in the following detailed description of the implementations, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Further, details may be omitted from certain of the drawings for clarity. Like reference numerals refer to like parts throughout the several views.

FIG. 1 is a perspective view of an embodiment of a jig.

FIG. 2 is another perspective view of the jig of FIG. 1.

FIG. 3 is another perspective view of the jig of FIG. 1.

FIG. 4 is a top view of the jig of FIG. 1.

FIG. 5 is a side view of the jig of FIG. 1.

FIG. 6 is an exploded view of the jig of FIG. 1 with an alternative top cover applied thereto.

FIG. 7 is a perspective view of the jig of FIG. 1 with the top cover removed.

FIG. 8 is a cross-sectional view along Section A-A in FIG. 4.

FIG. 9 is a cross-sectional view of FIG. 8 with an outline of a firearm frame applied thereto.

FIG. 10 is a cross-sectional view along Section B-B in FIG. 4.

FIG. 11 is a partial cross-sectional view along Section C-C in FIG. 5.

FIG. 12 is a perspective view of the top cover of FIG. 1.

FIG. 13 is another perspective view of the top cover of FIG. 1.

FIG. 14 is a perspective view of a drilling insert of FIG. 1.

FIG. 15 is a partial side view of the jig of FIG. 1.

FIG. 16 is a perspective view of a precision shoulder screw.

FIG. 17A is a right side view of a jig with bushings and precision shoulder screws installed.

FIG. 17B is left side view of the jig of FIG. 17A with bushings and precision shoulder screws installed.

FIG. 17C is a left side view of the jig of FIG. 17A with bushings and precision shoulder screws installed.

FIG. 17D is a right side view of the jig of FIG. 17A with precision shoulder screws installed and without bushings installed.

FIG. 17E is a left side view of the jig of FIG. 17A with precision shoulder screws installed and without bushings installed.

### DETAILED DESCRIPTION

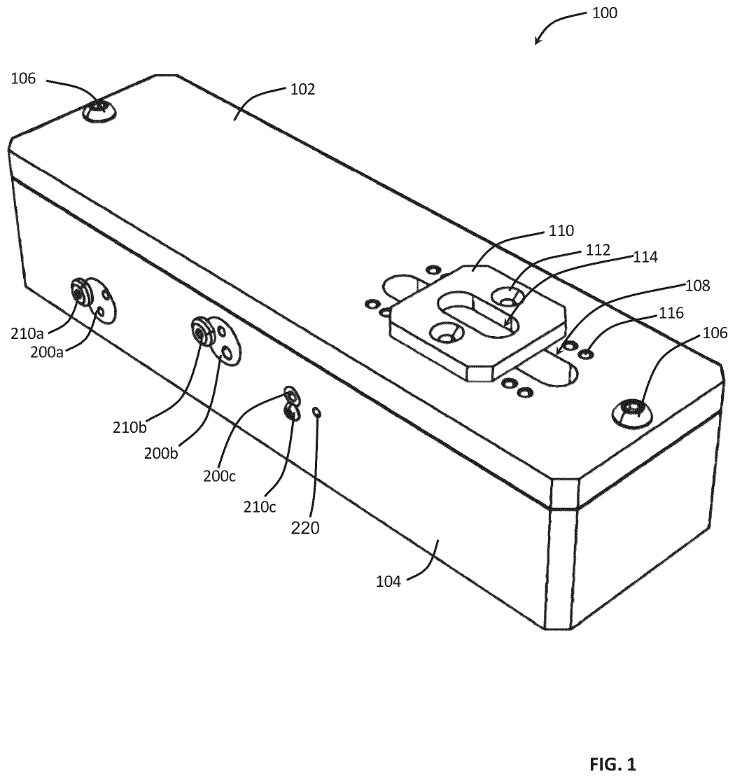

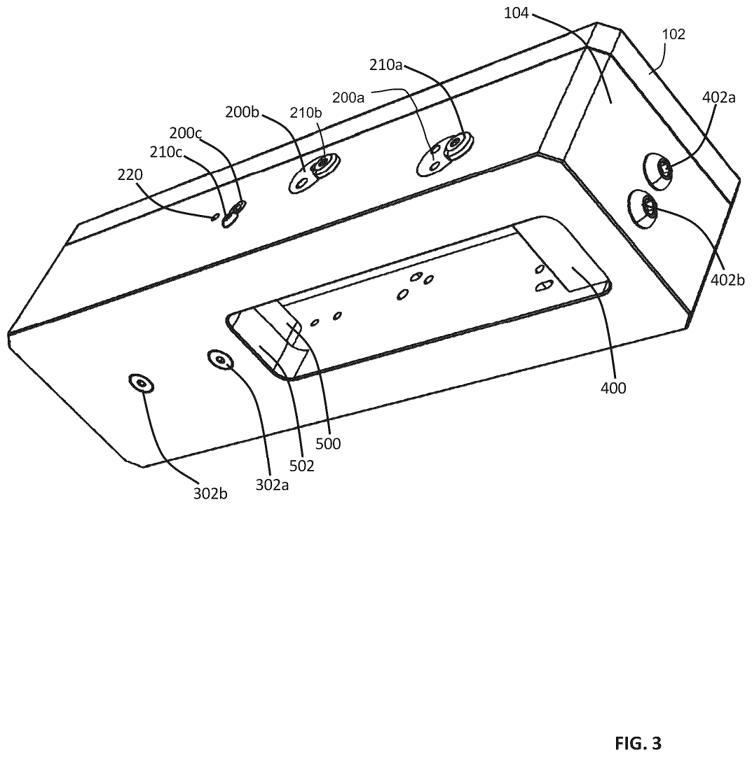

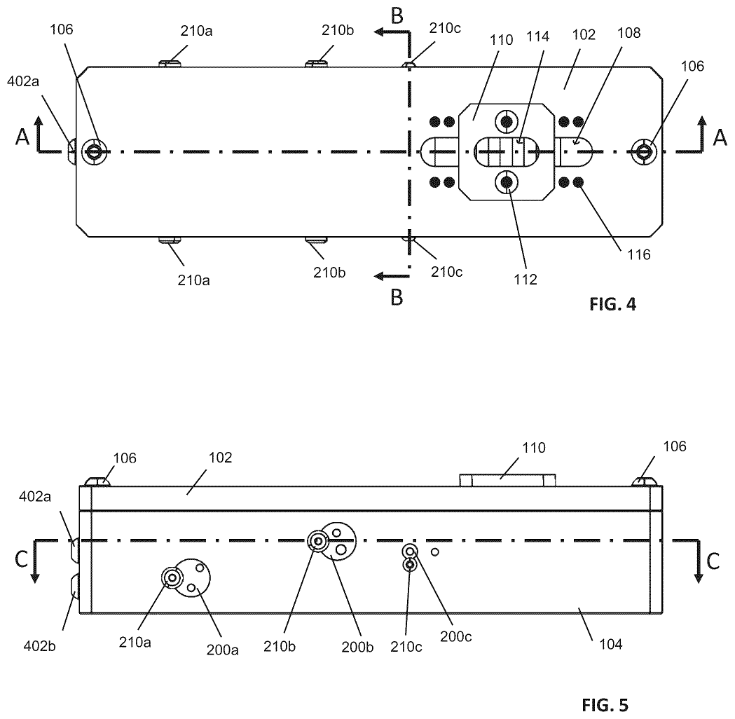

Referring to FIGS. 1-5, a jig 100 may comprise a top plate 102 and a main body 104. The top plate 102 may be selectively or releasably secured to the main body 104. For example, when the top plate 102 is removed, a blank frame may be inserted or placed within the main body 104. Thereafter, when the top plate 102 is attached or reattached to the main body 104, the top plate 102 may secure the blank frame within the jig 100.

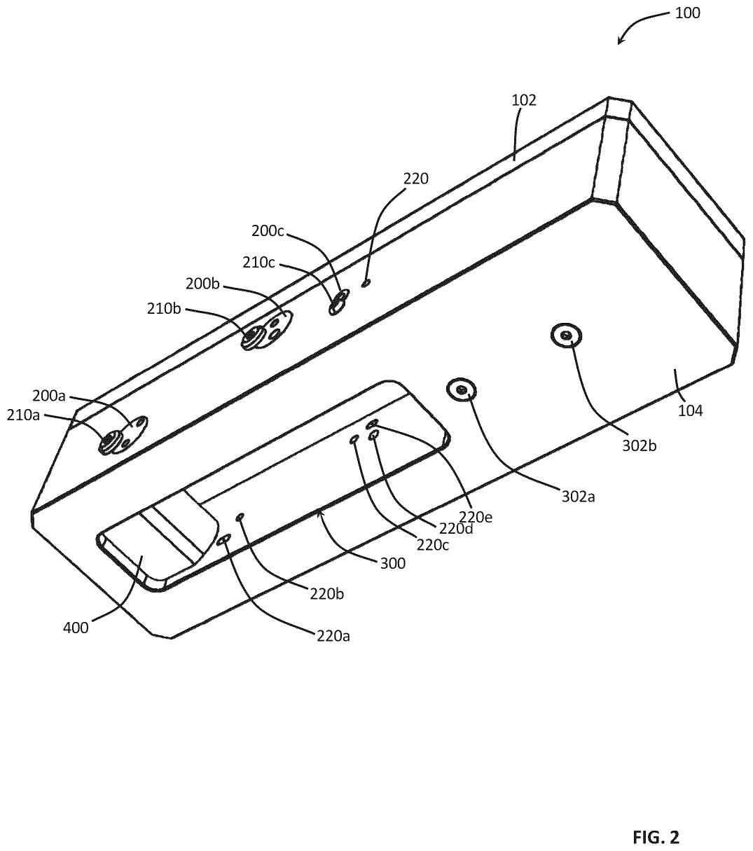

Referring to FIGS. 2, 3, and 5, the main body 104 may contain one or more bushing inserts 200a, 200b, 200c (individually or collectively referred to as 200), a rear matched-geometry insert or support, which in the illustrated embodiment is beavertail insert 400, a front matched-geometry insert or support, which in the illustrated embodiment is rail insert 500, or the like, or a combination or sub-combination thereof. The rear matched-geometry insert or support may match the geometry or support the geometry around the rear of a blank frame in order to provide alignment and a stable support, preventing side-to-side and up-and-down movement once the jig 100 is fully assembled. The front matched-geometry insert or support may match the geometry or provide support to the geometry around the front of a blank (e.g., a pistol) frame in order to provide alignment and a stable support preventing side-to-side and up-and-down movement once the jig 100 is fully assembled. The rear-matched geometry insert may also be positioned to register a location of a proximal end of a blank frame within the main body 104 and the front matched-geometry insert may be positioned to register a location of a distal end of a blank frame within the main body 104.

Opposing bushing inserts 200 or sets of bushing inserts 200 may be inserted into two opposite sides of the main body 104. The bushing inserts 200 may be arranged in a mirror image across a center plane of a main body 104. One or more fasteners 210a, 210b, 210c (individually or collectively referred to as 210) may secure the one or more bushing inserts 200 in place within the main body 104, thereby resisting relative rotation or other movement or misalignment between the bushing inserts 200 and the main body 104.

The bushing inserts 200 may function to locate, guide, and support a cutting tool (e.g., a drill bit, end mill, or the like) for precise machining of a blank frame contained within the jig 100 and may be aligned with a set of corresponding cutting holes 220 (also shown as cutting holes 220a, 220b, 220c, 220d, and 220e). The bushing inserts 200 are interchangeable and may use precision dowels to relocate precisely. The fasteners 210 may include precision shoulder screws or threaded button head bolts. The fasteners 210 may also integrate a precision dowel into a threaded bolt. Additionally, the fasteners 210 may consist of pressed-in steel dowels and one or more cap screws that interact with the edges of the respective bushing insert 200 to clamp it in place. The fasteners 210 function to provide the rotational accuracy and clamping force required to hold the bushing inserts 200 in place during manufacturing. The fasteners 210 also enhance the ability to interchange the bushing inserts 200.

The rear matched-geometry insert and the front matched-geometry, in the example the beavertail insert 400 and the rail insert 500, respectively, may be manufactured from aluminum using Computerized Numerical Control (CNC) machines before being anodized. They may also be manufactured using steel, 3-D printed plastic, casting, injection molding or another suitable material that gives the precision needed for locational accuracy.

The beavertail insert 400 may be made of aluminum or some other resilient material and may be shaped complementarily to the beavertail portion of a firearm. The beavertail insert 400 may fit into main body 104 of jig 100 in a vertical orientation and may be fastened into place by at least one beavertail fastener 402 (two fasteners 402a and 402b are shown by example). The beavertail fasteners 402 may be passed through a face of the main body 104 and into the beavertail insert 400 to secure the beavertail insert 400 in place. The beavertail fasteners 402 may maintain the position of the beavertail insert 400 and prevent its vertical or lateral movement during manufacturing and finishing. The beavertail insert 400 may have a radius or flat that interacts with the beavertail of a firearm while acting as a stop for the downward pressure on a part such as a pistol frame provided by the top plate 102. The beavertail insert 400 may be specifically matched to a size or type of blank frame and may be replaced to correspond with different blank frames or other parts to be cut. The beavertail insert 400 may also help to locate the rear or proximal end of a blank frame precisely in its relationship to the cutting holes 220 to prevent misalignment during machining. The cutting holes 220 may be cut out of the main body 104 to allow a cutting tool to pass through at a specific location to cut a blank frame contained therein.

The rail insert 500 may be made of aluminum or some other resilient material and may be shaped complementarily or in a mirror image to a picatinny rail or some other firearm rail. The rail insert 500 may be fit into the main body 104 and supported by a rail shelf 502 in a position within the main body 104 opposite where the beavertail insert 400 is located. In this position, the rail insert 500 can be fastened into place atop the rail shelf 502 by at least one rail insert fastener 302. The rail insert fasteners 302 may maintain the position of the rail insert 500 and prevent its vertical or lateral movement. The rail insert 500 in turn may prevent the movement of a blank frame contained within the main body 104 during cutting or finishing of the blank frame.

The surface of the rail insert 500 may precisely locate the front or distal end of a blank frame with respect to at least one cutting hole 220 to prevent misalignment during machining. The rail insert 500 also may act as a stop for the downward pressure provided by the top plate 102. Furthermore, because the rail insert 500 may have a complementary configuration to a blank frame, the rail insert 500 may also interlock with a portion of the blank frame and secure the blank frame in place within the main body 104 of the jig 100. Additionally, the rail insert 500 may be specifically matched to a size or type of blank frame and may be switched out to correspond with specific blank frames.

The jig 100 may be made of metal such as aluminum and machined to accept or contain a variety of components. The jig 100 may provide a high degree of resilience, accuracy, and repeatability over hundreds if not thousands of drilling and material removals. The main body 104 of the jig 100 may be made from one machined piece of rigid metal, such as aluminum. The main body 104 may be manufactured from a solid block of metal such as aluminum but it may also be manufactured from other materials such as steel, injection molded plastics, machined plastics, or 3-D printed metals or plastics. The main body 104 may also be manufactured via casting with finish machining performed. The main body 104 may also be split into two separate pieces that are fastened together. The construction of the main body 104 may function to limit movement and flex during the machining process. The sides of the main body 104 may be machined perpendicular to the angle of drill holes, which may allow precision items such as vices and drill presses to be used with little to no risk of movement or warping as is common with plastic jigs used under any minimally significant load.

A top plate 102 may be manufactured similarly to the main body 104 and positioned securely atop the main body 104 to secure a blank frame in place within the main body 104 of the jig 100 during drilling or material removal. The top plate 102 may be fastened down onto the main body 104 using one or more top plate fasteners 106. One or more top plate fasteners 106 may function to secure the top plate 102 onto the main body 104 and to provide a downward force on a blank frame contained within the jig 100. The top plate 102 along with the one or more top plate fasteners 106 may clamp the blank frame into place against the beavertail insert 400 and the rail insert 500, thus preventing any movement in the vertical or lateral directions during cutting.

At least one cover slot 108 may be cut out of the top plate 102 and may provide an opening for a cutting tool to be passed through for removal of material from a blank frame contained inside the jig 100. The at least one cover slot 108 may function to enhance or restrict the access of a cutting tool to a blank frame contained in the jig 100. The at least one cover slot 108 may also control the allowed depth and range of motion of a cutting tool while being passed through into the jig 100.

A secondary guide plate 110 may be fastened to the top plate 102 to help control the position of a cutting tool during the removal of material from a blank frame or other part contained in the jig 100. The secondary guide plate 110 may include at least one guide plate hole 112. The at least one guide plate hole 112 may pass through the entire depth of the secondary guide plate 110 and may allow the guide plate 110 to be attached to the top plate 102.

The secondary guide plate 110 may be fastened to the top plate 102 by positioning at least one guide plate hole 112 directly atop at least one guide plate attachment hole 116 and passing at least one fastener through the at least one guide plate hole 112 and into the at least one guide plate attachment hole 116. Guide plate attachment holes 116 may be included in the top surface of the top plate 102 and allow the secondary guide plate 110 to be selectively attached to the top plate 102. The position for attachment of the secondary guide plate 110 on the top plate 102 may be determined by placing bolts or other fasteners through the at least one guide plate hole 112 and then through the at least one guide plate attachment hole 116 aligned directly underneath.

The secondary guide plate may also include least one guide plate channel 114. The secondary guide plate channel 114 may allow for cutting tools to pass through the secondary guide plate 112. The secondary guide plate channel 114 may be aligned above the cover slot 108 to allow a cutting tool to pass through both the secondary guide plate 114 and the top plate 102. The position of secondary guide plate 110 and thus the secondary guide plate channel 114 may be adjusted by changing the placement of the at least one guide plate holes 112 with respect to the at least one guide plate attachment hole 116.

Additionally, the dimensions of the guide plate channel 114 may function to enhance or restrict the access of cutting tools of various sizes to a blank frame contained within the jig 100. Secondary guide plates 110 of various heights and with guide plate channels 114 of various dimensions may be used to further restrict or enhance the location of a cutting tool for the correct depth and length of material removal. Furthermore, secondary guide plates 110 may be specifically indicated and labeled to the type of blank frame being cut.

The top plate 102 and secondary guide plate 110 may be replaced after wear and tear for use with the main body 104 if necessary. Likewise, the main body 104 may be replaced with respect to the top plate 102 and/or the secondary guide plate 110. The secondary guide plate 110 may be manufactured similarly to or differently from the main body 104 and/or the top plate 102.

A bottom aperture 300 may be included in the main body 104. The bottom aperture 300 may be located on the bottom face of the main body 104 and may extend through the entire depth of the main body 104. The bottom aperture 300 may be shaped in a complementary manner to part of a blank frame or other part and provide access to a blank frame while contained within the jig 100. The bottom aperture 300 may also allow the grip of a blank frame to pass through while the blank frame is contained within the jig 100. Additionally, the bottom aperture 300 may be configured to contain the beavertail insert 400. The interior surface of the bottom aperture 300 may also include cutting holes 220. The locations of the cutting holes 220 may function to allow for precise and consistent cutting of a part contained within the main body 104.

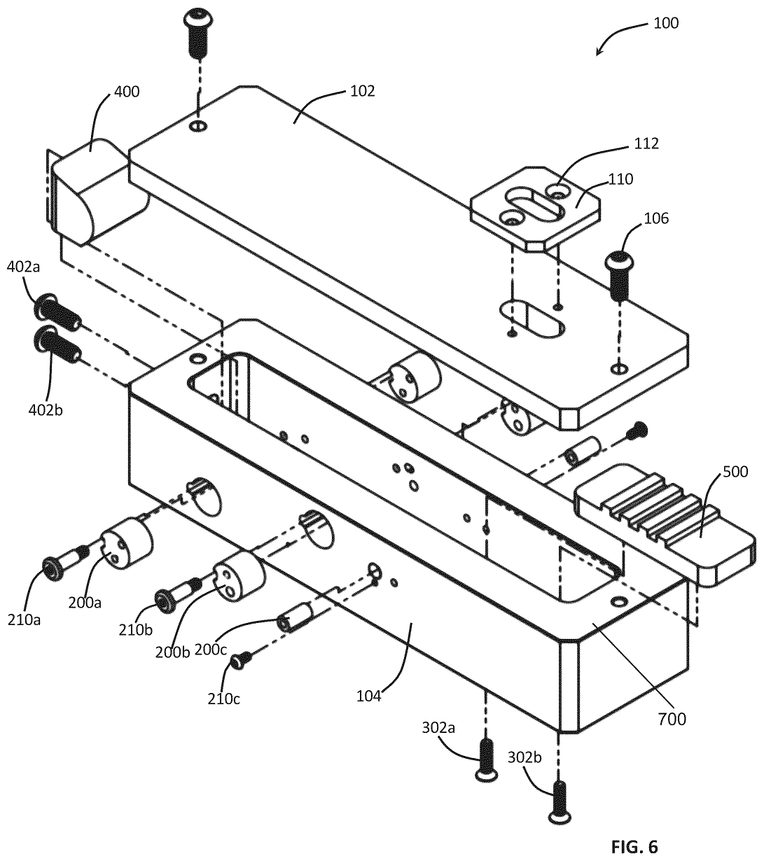

Referring to FIGS. 6 and 7, the components of the jig 100 when used together may provide a device that accurately locates a blank frame in its desired position within the jig 100 and allows for stable positioning. The stable position of the blank frame contained within jig 100 allows for a cutting tool to be used effectively and consistently. The components of jig 100 may work in harmony to achieve correct positioning and the components may be specific to certain models or designs of blank frames. At the same time, the components may also be used individually or in any combination. The components of the jig 100 are reusable many times over and may be changed out to suit a variety of blank frames or parts to be finished, as they provide a variety of cutting configurations. This aspect of the jig 100 also provides the ability to expand the number of blank frames the jig 100 will work with, as it can be easily adapted to accommodate when new blank frames are developed. Additionally, the components of the jig 100 may be manufactured using CNC machines, vertical milling machines, horizontal milling machines, lathes, Swiss machines, or other methods.

The rail insert 500 and the beavertail insert 400 are designed to be completely replaceable if that need may ever arise. The rail insert 500 and the beavertail insert 400 may be made to be moveable with several fastener holes for fasteners to accommodate different blank frames using any combination of the rail insert 500 and/or the beavertail insert 400. As best seen in FIG. 6, fasteners 302a and 302b secure the rail insert to the main body 104, and fasteners 402a and 402b secure the beavertail insert 400 to the main body 104.

The top plate 102 is placed onto the top face 700 of the main body 104 and fastened to the top face 700. The top face 700 may serve as a stop for the top plate 102 when it is placed onto main body 104. The top plate 102 may be securely attached to the top face 700 with at least one top plate fastener 106 that is passed through the top plate 102 and into at least one top face hole 706, which includes two top face holes 706a and 706b in the example of FIG. 7. The fastening of the top plate 102 to the top face 700 of main body 104 may assist in holding a firearm frame accurately in place during machining. The dimensions and shape of the top face 700 may be varied to provide a variety of contact surfaces for the top plate 102.

Secondary guide plates 110 of varying designs may be interchanged and fastened to the top plate 102 to help control the location and depth of a material removal tool during the machining of a central guide rod channel or other part of a firearm frame across various platforms of firearm blanks. The guide plate holes 112 may allow different heights of secondary guide plates 110 to be attached to the top plate 102 that can further restrict or enhance location for the correct depth and length of cutting of a blank frame or other part.

The overall design of the jig 100 may be modular in a fashion that allows it to be adapted and expanded to fit other firearm frames and parts as they may come to market. The modularity of the jig 100 means that it may be adapted to fit virtually any personally manufactured blank frame of similar size or construction, and the modularity also allows for replacement parts to be exchanged when needed, thus increasing the life of the jig dramatically.

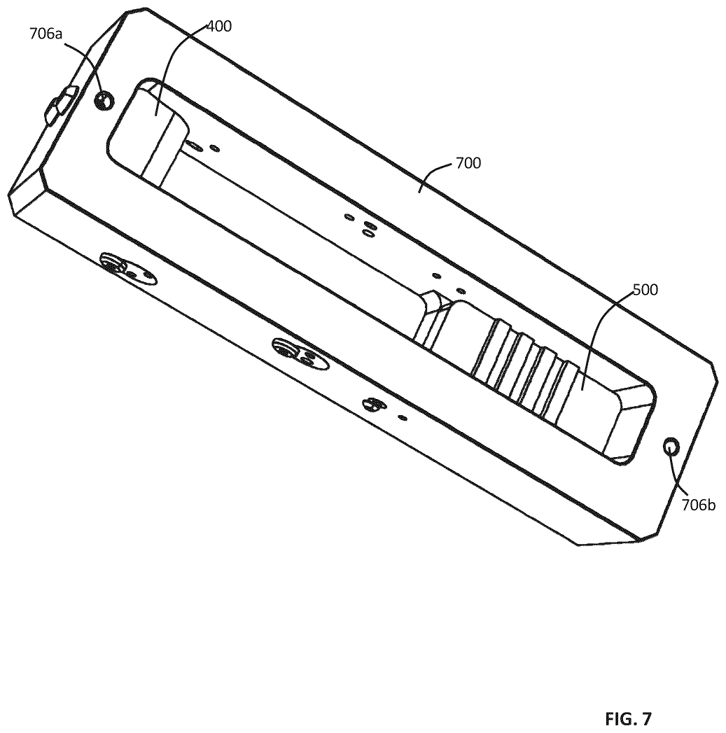

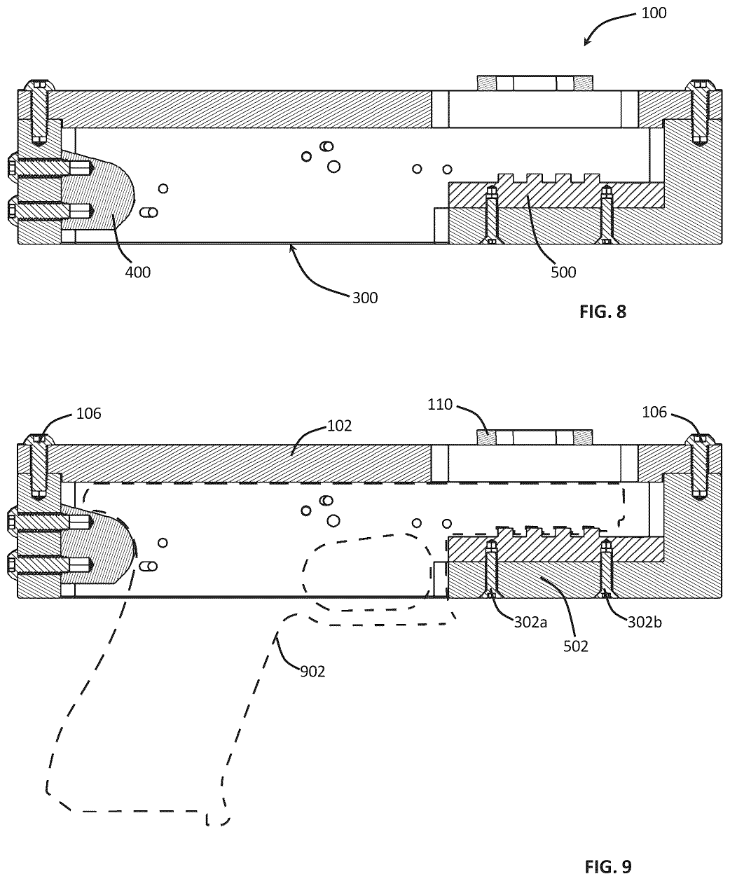

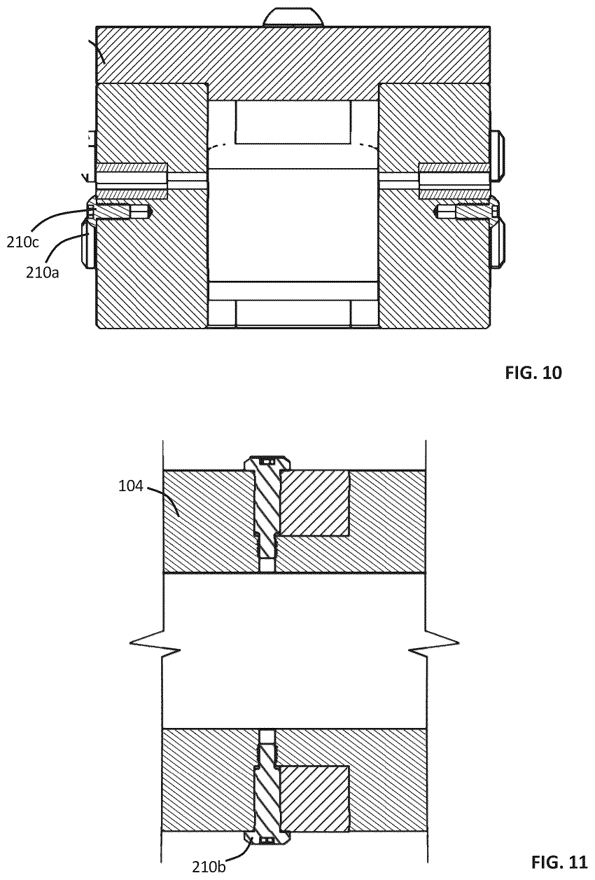

Referring to the cross-sectional views of FIGS. 8-11, a blank frame 902 may be inserted into the assembled jig 100 to be cut. The blank frame 902 may vary in shape, design, or model. The blank frame 902 may be finished within the jig 100 before other components being installed onto the blank frame 902.

Corresponding drill bushing inserts may be inserted into both sides of the main body 104 of the jig in a mirror image down the centerline and clamped/located via the fasteners 210 into their precise rotation and location needed for manufacture. The rail insert 500 may fit into a pocket main body of the jig 100 and rest on the rail shelf 502 located at one end of the jig 100. The rail shelf 502 may function to support and provide an attachment point for the rail insert 500 as well as improve the stability and prevent movement of the blank frame 902 while contained within the jig 100. The rail shelf 502 may also help prevent misalignment of a cutting tool. The rail insert 500 may be secured into place atop the rail shelf 502 by at least one rail fastener 302 (in this example, the fasteners 302a and 302b). The at least one rail fastener 302 may be passed through the main body 104 and the rail shelf 502 and into the rail insert 500.

After a blank frame 902 is inserted into the jig 100 the top plate 102 may be clamped down using at least one top plate fastener 106, securing the blank frame 902 in its location. A secondary guide plate 110 may be secured to the top plate 102 using additional fasteners. Once the jig 100 has been assembled, holes specific to the blank frame 902 being manufactured contained within the bushing inserts may be used as a drill guide for a router or a cutting tool.

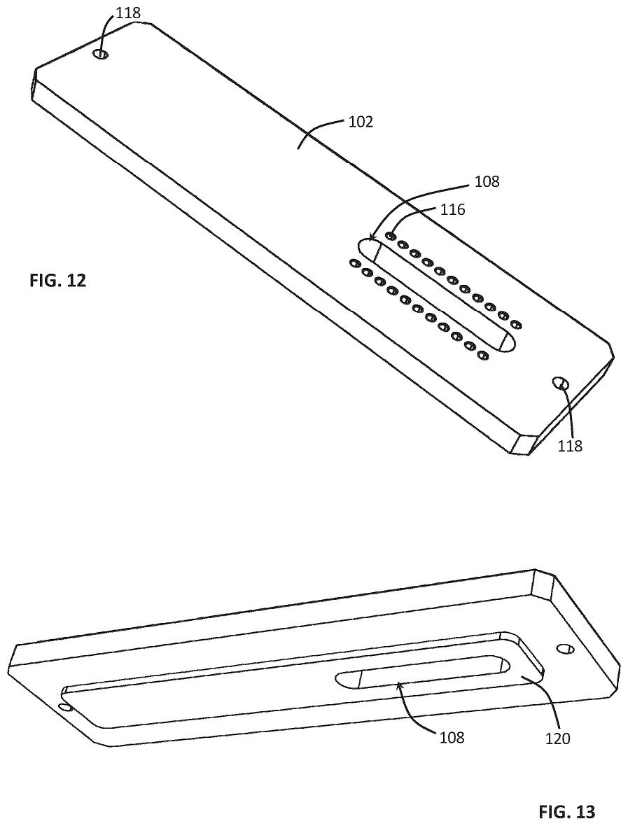

Referring to FIGS. 12 and 13, at least one top plate fastener may be used to clamp the top plate 102 down via at least one top plate hole 118. The at least one top plate hole may pass through the entire depth of the top plate 102. This may allow the top plate 102 to interact with a blank frame by pushing it down into the jig, securing the blank frame, and preventing any movement or misalignment during cutting. The top plate 102 may be replaced for wear and tear or to account for different blank frames or parts to be machined. The cover slot 108 may be included in top plate 102 to provide an opening for a material removal tool to be passed through for removal of the guide rod channel or other portion of a blank frame. Additional cover slots 108 of other shapes or locations may be included to allow removal of material from a firearm frame or part. The top surface of the top plate 102 may also include a variety of configurations of guide plate attachment holes 116. Additional top plate holes 118 may be included in the top plate 102 that allow for removal of specific material from a blank frame with a router.

Additionally, the underside of the top plate 102 may include a top plate protrusion 120. The top plate protrusion 120 may extend downward from the bottom surface of the top plate 102. The top plate protrusion 120 may vary in its shape and dimension and may provide the appropriate amount of pressure or contact with the contents of the jig 100. The top plate protrusion 120 may also provide a more secure fit of the top plate 102 onto the main body 104 of the jig 100 by extending beyond the top surface of the jig 100 and interacting with the inside surface of the main body 104 of the jig 100. The top plate protrusion 120, when present, may be shaped complementarily to the top surface of the main body.

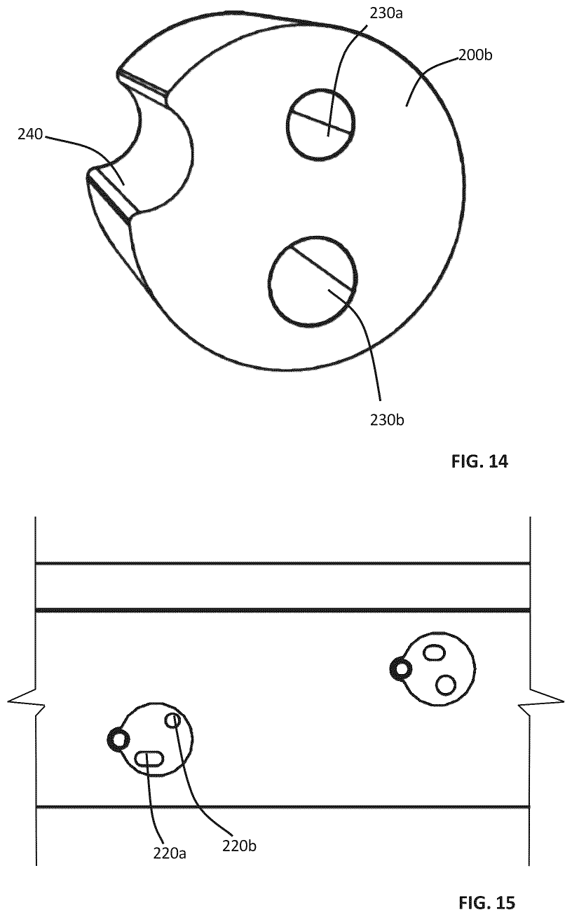

Referring to FIGS. 14 and 15, bushing inserts 200 (such as the bushing insert 200b) may be inserted into at least one side of the main body 104. The bushing inserts 200 may be specifically manufactured from a hardened steel. The bushing inserts 200 may also be treated with a resilient coating that may increase their life expectancy. The bushing inserts 200 may also be made of steel or some other high strength or resilient materials. The bushing inserts 200 may also be in various polygonal, oval, or geometric shapes that may assist in locating holes correctly while guaranteeing the location and position of the bushing insert 200.

Additionally, precision fasteners 210 may be used as bushing retention bolts, clamping the surface of bushing inserts 200 to the lower machined surface of a bushing pocket. The fasteners 210 may include precision shoulder screws or threaded button head bolts. The bushing inserts 200 may also include at least one bushing notch 240. The precision fasteners 210 may be sized to fit securely within respective bushing notches 240. A bushing notch 240 may vary in size and dimension to accommodate a range of precision fasteners 210 and may provide a surface against which the fasteners 210 may locate.

Bushing guides 230 may also be included in the bushing inserts 200. In the examples herein, each bushing insert 200 has one or two bushing guides 230 (e.g., aligned with a respective cutting hole 220). For example, the bushing insert 200b shown in FIGS. 14 and 15 has two bushing guides 230a and 230b. The number, configuration, and shape of the bushing guides 230 may vary to provide a variety of positions for a drill bit or cutting tool to pass through. The bushing inserts 200 may be configured in a variety of positions within the jig in a prescribed way to maintain precision. The bushing inserts 200 may be designed to be completely replaceable and may also be color-coded and/or labeled with respect to the bushing guides 230 and/or the bushing notches 240. The bushing inserts 200 may also be labeled in some manner and combined with instructions that may ensure the appropriate combination of bushing inserts 200 are used. The bushing inserts 200 may allow a user the ability to precisely drill holes into a blank frame for subsequent accurate insertion of parts into the blank frame. In turn, this may increase the overall integrity of the finished product made from the blank frame.

In some embodiments, six different bushing inserts 200 may be arranged 3 per parallel side in a jig. The bushing inserts 200 may be specifically indicated to a size or type of blank frame, that can be inserted in the jig and held in a specific location by a corresponding precision fastener 210 and at least one cap screw that may interact with the edges of the bushing insert 200, a bushing notch 240, or a bushing pocket in the jig to clamp the bushing insert 200 in place. The jig may also be used without the presence of bushing inserts 200.

Removing the bushing inserts 200 may allow for another view and use of the cutting holes 220. The cutting holes 220 may vary in size and shape. The shape and size of the cutting holes 220 may allow for a variety of cutting tools to be used with the jig 100. Additionally, some or all of the cutting holes 220 may be oval or oblong in shape to allow for various types and alignments of bushings. The configuration of the cutting holes 220 may also be varied to correspond with a variety of blank frames.

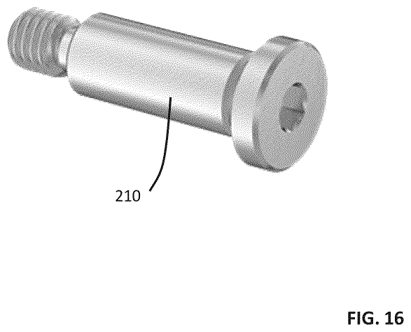

Referring to FIG. 16, the fasteners 210 may include fasteners of various types. The fasteners 210 may include precision shoulder screws, an example of which is shown in FIG. 16. The precision shoulder screw may integrate a precision dowel into a threaded bolt. The fastener 210 may include a dowel portion and a threaded portion. This may improve the manufacturability of the components, including the bushing notches 240. Furthermore, the precision shoulder screws may allow for increased customizability and increase the overall lifespan of the jig 100.

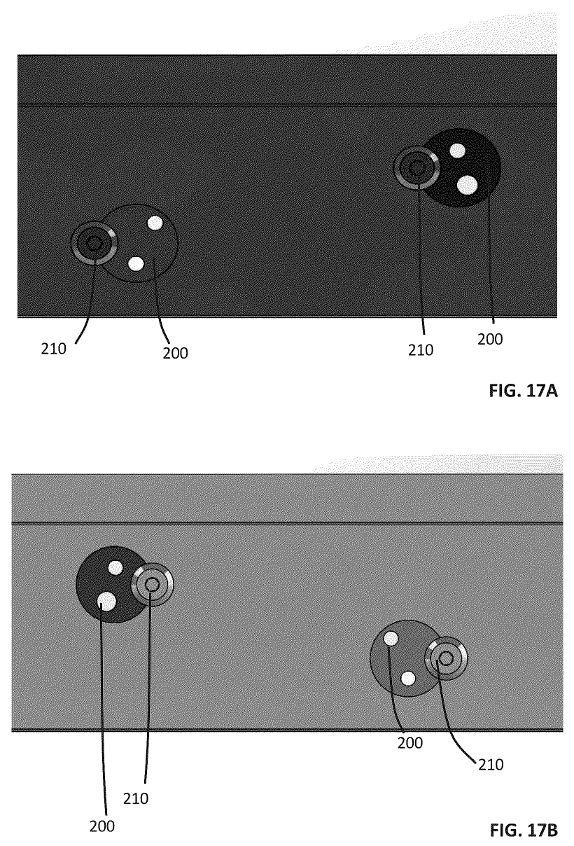

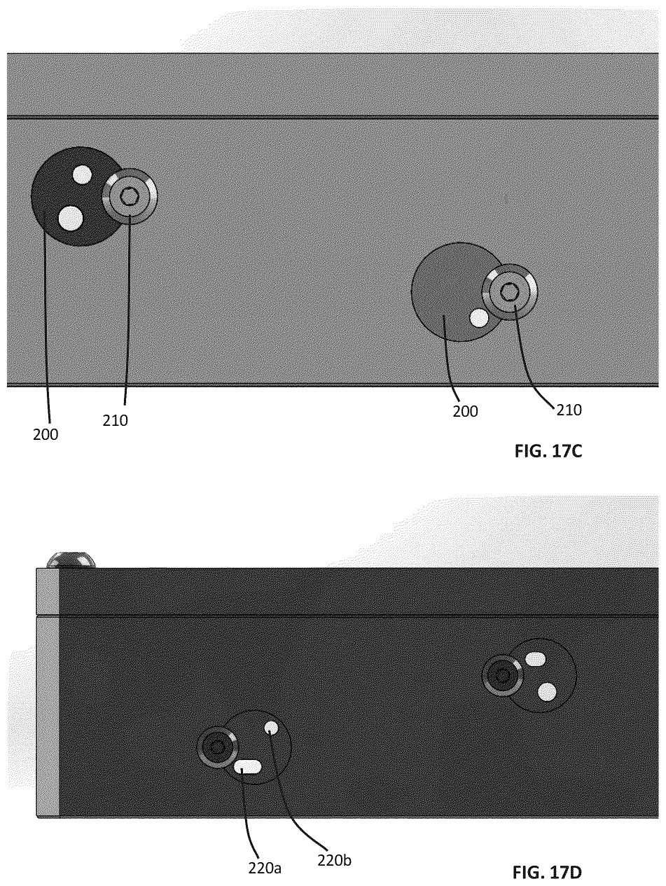

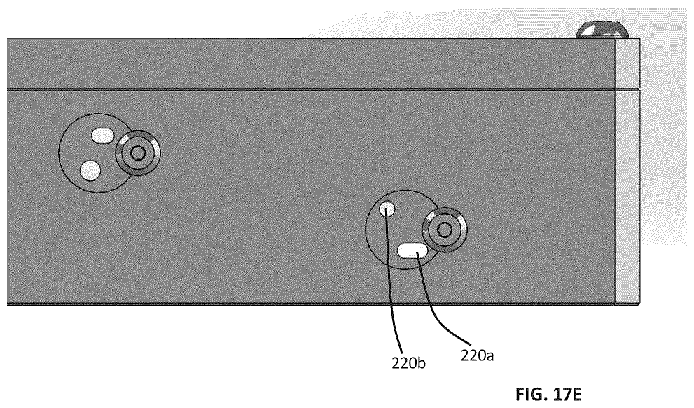

Referring to FIGS. 17A and 17B, bushing inserts 200 may be used for a Compact-style firearm frame. The right or the left side of the jig 100 may have bushing inserts 200 with holes that align with the desired positions for machining a Compact-style firearm frame. For example, the left side (FIG. 17B) of the jig 100 may have bushing inserts 200 with holes that align with the front of the slot of a Compact-style firearm frame.

Referring to FIGS. 17C and 17D, bushing inserts 200 may also be used for a PF45 firearm frame. The right or left side of the jig 100 may have bushing inserts that align with the desired positions for machining a PF45 firearm frame. For example, the left side of the jig 100 (FIG. 17C) may have bushing inserts 200 with a hole that aligns with the back of the slot of a PF45 firearm frame. The right side of the jig 100 (FIG. 17D) may be used without bushing inserts, and the frame may be machined through the cutting holes 220.

Referring to FIGS. 15, 17D, and 17E, different shapes of cutting holes 220, for example cutting holes 220a, 220b, may be used for machining a firearm frame. For example, elongated slots or oblong-shaped cutting holes (e.g., 220a) and circular cutting holes (e.g., 220b) may be used in the jig 100. In finishing steps between two different models of firearm frames, the positions for two desired cutting holes 220 may be very close to each other. The positions of the cutting holes 220 may even be prohibitively close. For example, simply machining the cutting holes 220 in the desired locations in the jig 100 may cause a bulge, collapse, or other structural damage in the walls of the jig 100. A differently shaped cutting hole 220 (e.g., in the form of a slot) may be utilized in the jig 100. The two cutting holes 220 may be connected in the jig 100. Additionally, two holes may be created close together in the finishing process.

Bushing inserts 200 (e.g., steel bushing inserts) may be used to precisely locate positions for holes. The positions of desired hole locations (e.g., one above the trigger pin, one by the trigger housing) may be determined using the tangential relationship between holes and either side of the slot depending on the configuration. Pins may also help with alignment through the holes as the bushing is fastened in place before final finishing of the frame. During assembly and drilling, pins may be used to aid in alignment through the holes as the bushing is fastened in place before final finishing of the frame. Any existing molded holes on the frame may also be used to further enhance alignment and secure the frame within the jig by passing a pin through opposing bushing inserts 200 while also passing the same pin through the frame. Any hole in any bushing may be used, for example, a hole that already exists or a hole that has been drilled to provide alignment for continued finishing.

The above-described implementations and other aspects have been described to facilitate easy understanding of the disclosure, and do not limit the disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

What is claimed is:

1. A jig for machining firearm frames, comprising:
a main body;
a top plate covering the main body and shaped and sized to secure a firearm frame within the main body;
a bushing pocket extending at least partially through the main body;
a rear matched-geometry insert fastened within the main body and positioned to register a location of a proximal end of the firearm frame within the main body; and
a front matched-geometry insert fastened within the main body and positioned to register a location of a distal end of the firearm frame within the main body.

2. The jig of claim 1, wherein the top plate comprises:
a top plate hole sized and shaped to receive a fastener; and
a top plate slot sized and shaped to receive a cutting tool.

3. The jig of claim 1, further comprising:
a bushing insert positioned within the bushing pocket.

4. The jig of claim 3, wherein the bushing insert comprises a bushing guide passing therethrough.

5. The jig of claim 4, further comprising:
a precision fastener securing the bushing insert within the bushing pocket.

6. The jig of claim 5, wherein the bushing insert further comprises a bushing notch sized and shaped to accommodate the precision fastener.

7. The jig of claim 6, wherein the precision fastener comprises a precision dowel and a threaded bolt.

8. A jig for machining firearm frames, comprising:
a main body;
a top plate covering the main body and securing a firearm frame within the main body, the top plate having a top plate hole being sized and shaped to receive a fastener, a cover slot being sized and shaped to receive a cutting tool, and a guide plate attachment hole being sized and shaped to receive a fastener;
a secondary guide plate covering at least a portion of the top plate;
a bushing pocket extending at least partially through the main body;
a rear matched-geometry insert fastened within the main body and positioned to register a location of a proximal end of the firearm frame within the main body; and
a front matched-geometry insert fastened within the main body and positioned to register a location of a distal end of the firearm frame within the main body.

9. The jig of claim 8, wherein the secondary guide plate comprises:
a guide plate channel sized and shaped to receive a cutting tool; and
a guide plate hole sized and shaped to receive a fastener.

10. The jig of claim 9, wherein the secondary guide plate is fastened to the top plate so that the guide plate hole is aligned with the guide plate attachment hole and the guide plate channel is at least partially aligned with the cover slot.

11. The jig of claim 8, further comprising:
at least one bushing insert corresponding with the at least one bushing pocket.

12. The jig of claim 11, wherein the bushing insert comprises at least one bushing guide passing therethrough.

13. The jig of claim 12, further comprising:
a precision fastener securing the bushing insert within the bushing pocket.

14. The jig of claim 13, wherein the bushing insert further comprises a bushing notch sized and shaped to accommodate the precision fastener.

15. The jig of claim 14, wherein the precision fastener comprises a precision dowel and a threaded bolt.

16. A method of machining a firearm frame, comprising:
securing a firearm frame within a main body of a jig, the jig including:
the main body,
a top plate having a top plate hole being sized and shaped to receive a fastener, a cover slot being sized and shaped to receive a cutting tool, and a guide plate attachment hole being sized and shaped to receive a fastener,
a secondary guide plate having a guide plate channel sized and shaped to receive a cutting tool and a guide plate hole being sized and shaped to receive a fastener,
a bushing pocket extending at least partially through the main body,
a rear matched-geometry insert fastened within the main body and positioned to register a location of a proximal end of the firearm frame within the main body, and
a front matched-geometry insert fastened within the main body and positioned to register a location of a distal end of the firearm frame within the main body;
fastening the top plate atop the main body;
fastening the secondary guide plate atop the top plate such that at least a portion of the guide plate channel is aligned above the cover slot;
cutting into the firearm frame via the bushing pocket; and
cutting into the firearm frame via the cover slot via the guide plate channel.

17. The method of claim 16, further comprising:
inserting a bushing insert into the bushing pocket.

18. The method of claim 17, further comprising:
inserting a precision fastener into the bushing.

19. The method of claim 16, further comprising:
inserting a pin through a wall of the main body and into the firearm frame.

20. The method of claim 19, wherein inserting the pin through the wall of the main body and into the firearm frame includes inserting the pin through the firearm frame and at least into an opposite wall of the main body.
